(19) United States
(12) Patent Application Publication
(10) Pub. No.: US 2023/0024707 A1
(43) Pub. Date: Jan. 26, 2023

(54) SYSTEM AND METHOD FOR CLASSIFYING A USER TO APPLY FOR A MICROLOAN USING ML MODEL

(71) Applicant: MoMagic Technologies Private Limited, New Delhi (IN)

(72) Inventors: Arun Kumar Gupta, New Delhi (IN); Saurabh Kathpalia, New Delhi (IN); Shipra Mittal, New Delhi (IN)

(21) Appl. No.: 17/856,955

(22) Filed: Jul. 2, 2022

(30) Foreign Application Priority Data
Jul. 6, 2021 (IN) 202111030376

(51) Int. Cl. G06Q 40/02; G06N 5/02

(52) U.S. Cl. CPC G06Q 40/025; G06N 5/022

(57) ABSTRACT

A system for classifying to apply for a microloan by a user is provided. The system includes user device associated with a user, and loan applying user classification system. The loan applying user classification system 106 collects raw data from at least one of (i) one or more programs on the user device directly; (ii) the one or more programs indirectly through the network or (iii) both. The raw data includes mobile brand, screen height, demographic details, mcc, session timestamp, sessionid, session duration, etc. The loan applying user classification system is configured to (i) pre-process the raw data to obtain pre-processed data; (ii) identify representative set of features (i.e. training dataset) from the pre-processed data; (iii) balance an imbalanced training dataset to obtain balanced dataset; and (iv) generate a classification model using balanced dataset to classify in applying for micro-loan by the user.

### CROSS-REFERENCE TO PRIOR-FILED PATENT APPLICATIONS

This application claims priority from the Indian provisional application no. 202111030376 filed on Jul. 6, 2021, which is herein incorporated by reference.

### BACKGROUND

### Technical Field

The embodiments herein generally relate to a classification system, and more particularly to a system and method for classifying to apply for a microloan by a user using a machine learning model based on a categorization of user data.

### Description of the Related Art

A crucial part of any loan-lending operation is identifying potential users (i.e. customers) which improves loan lender's decision-making and target-marketing processes. Higher User acquisition costs and unavailability of user credit history are major challenges for loan lenders and hence emerged as important business problems. This is more challenging where a majority of new users don't have any credit history (score) and every registered user does not necessarily convert to a loan borrower. Hence, loan lenders need to know their potential users (who will apply for a loan) as early as possible to exploit better business and marketing opportunities.

In recent years, machine learning techniques are utilized to identify potential customers. In some existing approaches, various historical personal and financial data (e.g., occupation, education, income details, credit history, etc.) obtained from the users are utilized to analyze the creditworthiness, interests, and behavior of the users. However, in the case of students, unbanked adults, and users with no credit history, such data is not readily available.

In some existing approaches, potential customers are identified with the machine learning models that are trained with non-financial behavioral data of the customers (e.g. website visiting behavior). However, these approaches are ineffective in terms of high consumption of manpower and time, high user acquisition cost, and false acquisition.

Accordingly, there remains a need to address the aforementioned technical drawbacks in existing technologies in accurately identifying the potential users with low user acquisition cost, manpower resources, and time.

### SUMMARY

In view of the foregoing, an embodiment herein provides a processor-implemented method for classifying a user to apply for a microloan based on a categorization of user data using a machine learning model. The method includes obtaining a first data input from the user device associated with the user and receiving, using a data collecting unit, a second data input from one or more data sources. The method includes categorizing the first data input and the second data input to determine a categorized data based on a definition of a first type of data, a second type of data, and a third type of data. The method includes pre-processing, using a data management unit, the categorized data to determine pre-processed data, the pre-processed data includes one or more features. The method includes selecting, using a correlation technique, one or more features to obtain a selected one or more features. The method includes sampling the selected one or more features to obtain a balanced dataset that is used to train the machine learning model. The method includes training the machine learning model by correlating the balanced dataset with a classification of the user to obtain a trained machine learning model, the classification of the user is at least one of (a) the user applies for the microloan as positive events, or (b) the user does not apply for the microloan as negative events. The method includes classifying, using the trained machine learning model, the user for applying the microloan based on at least one of the first data input, or the second data input.

In some embodiments, the method includes transforming the selected one or more features by, (i) encoding categorical variables of one or more features to obtain a new set of features indicating the presence or absence of each label value from the selected one or more features and (ii) scaling numerical attributes to the values of numerical attributes in a fixed range.

In some embodiments, the categorized data includes, (i) a first type of data that includes one or more details of the user device, (ii) a second type of data that includes demographic data of the user, and (iii) a third type of data that includes user's online interaction data.

In some embodiments, the method includes selecting, using the correlation technique, the one or more of features at least by (i) measuring an association between the categorical variables of the one or more of features that is bounded within the range [0,1], where 0 signifies no association and 1 signifies perfect association, or (ii) measuring an association between the numerical attributes.

In some embodiments, the method includes removing one of two categorical variables of the set of features whose degree of correlation is greater than a pre-set threshold value.

In some embodiments, the method includes encoding the categorical variables of one or more features by converting each label values to new dichotomous variables to indicate the presence of each possible value from one or more features and scaling numerical attributes to the values of numerical attributes in the fixed range such that the mean of the numerical attributes is zero, and corresponding standard deviation is one.

In some embodiments, the method includes validating a predicted classification of the user by the trained machine learning model with corresponding real-time data of classification of the user to improve accuracy of the method.

In some embodiments, the method includes retraining the machine learning model if there is a misalignment between the classification of the user with real-time data by determining positive events and negative events, the positive events and the negative events samples that are used in retraining the machine learning model.

In some embodiments, the categorized data is pre-processed by, (i) extracting, using a data management unit, data from the categorized data to obtain structured data; (ii) transforming, using a data transformation technique, the structured data into a transformed data; and (iii) standardizing the transformed data by standardizing cases, dealing with missing information, null values, or outliers to obtain the pre-processed data.

In another aspect, a system for classifying a user to apply for a microloan based on a categorization of user data using a machine learning model is provided. The system includes a memory that stores a database and a set of instructions and a processor that is configured to execute the set of instructions and is configured to (i) obtain a first data input from the user device associated with the user and receive, using a data collecting unit, a second data input from one or more data sources, (ii) categorize the first data input and the second data input to determine a categorized data based on a definition of a first type of data, a second type of data and a third type of data, (iii) pre-process, using a data management unit, the categorized data to determine pre-processed data, the pre-processed data includes one or more features, (iv) select, using a correlation technique, one or more features to obtain selected one or more features, (v) sample the selected one or more features to obtain a balanced dataset that is used to train the machine learning model, (vi) train the machine learning model by correlating the balanced dataset with a classification of the user to obtain a trained machine learning model, the classification of the user is at least one of (a) the user applies for the microloan as positive events, or (b) the user does not apply for the microloan as negative events, (vii) classify, using the trained machine learning model, the user for applying the microloan based on at least one of the first data input, or the second data input.

In some embodiments, the processor is configured to include transforming the selected one or more features by, (i) encoding categorical variables of one or more features to obtain a new set of features indicating the presence or absence of each label value from the selected one or more features and (ii) scaling numerical attributes to the values of numerical attributes in a fixed range.

In some embodiments, the categorized data includes, (i) a first type of data that includes one or more details of the user device, (ii) a second type of data that includes demographic data of the user, and (iii) a third type of data that includes user's online interaction data.

In some embodiments, the processor is configured to include selecting, using the correlation technique, the one or more of features at least by (i) measuring an association between the categorical variables of the one or more of features that is bounded within the range [0,1], where 0 signifies no association and 1 signifies perfect association, or (ii) measuring an association between the numerical attributes.

In some embodiments, the processor is configured to include removing one of two categorical variables of the set of features whose degree of correlation is greater than a pre-set threshold value.

In some embodiments, the processor is configured to include encoding the categorical variables of one or more features by converting each label values to new dichotomous variables to indicate the presence of each possible value from one or more features and scaling numerical attributes to the values of numerical attributes in the fixed range such that the mean of the numerical attributes is zero, and corresponding standard deviation is one.

In some embodiments, the processor is configured to include validating a predicted classification of the user by the trained machine learning model with corresponding real-time data of classification of the user to improve accuracy of the method.

In some embodiments, the processor is configured to include retraining the machine learning model if there is a misalignment between the classification of the user with real-time data by determining positive events and negative events, the positive events and the negative events samples that are used in retraining the machine learning model.

In some embodiments, the categorized data is pre-processed by, (i) extracting, using a data management unit, data from the categorized data to obtain structured data; (ii) transforming, using a data transformation technique, the structured data into a transformed data; and (iii) standardizing the transformed data by standardizing cases, dealing with missing information, null values, or outliers to obtain the pre-processed data.

In another aspect, there is provided one or more non-transitory computer-readable storage mediums storing one or more sequences of instructions, which when executed by one or more processors, causes a method for classifying a user to apply for a microloan based on a categorization of user data using a machine learning model. The method includes obtaining a first data input from the user device associated with the user and receiving, using a data collecting unit, a second data input from one or more data sources. The method includes categorizing the first data input and the second data input to determine a categorized data based on a definition of a first type of data, a second type of data, and a third type of data. The method includes pre-processing, using a data management unit, the categorized data to determine pre-processed data, the pre-processed data includes one or more features. The method includes selecting, using a correlation technique, one or more features to obtain a selected one or more features. The method includes sampling the selected one or more features to obtain a balanced dataset that is used to train the machine learning model. The method includes training the machine learning model by correlating the balanced dataset with a classification of the user to obtain a trained machine learning model, the classification of the user is at least one of (a) the user applies for the microloan as positive events, or (b) the user does not apply for the microloan as negative events. The method includes classifying, using the trained machine learning model, the user for applying the microloan based on at least one of the first data input, or the second data input.

### BRIEF DESCRIPTION OF THE DRAWINGS

The embodiments herein will be better understood from the following detailed description with reference to the drawings, in which:

FIG. 1 illustrates a block diagram of a system for classifying a user to apply for a microloan according to some embodiments herein;

FIG. 2 illustrates a block diagram of a loan applying user classification system of FIG. 1 according to some embodiments herein;

FIG. 3 illustrates a block diagram of a pre-processing module of FIG. 2 according to some embodiments herein;

FIG. 4 is a flow diagram that illustrates a method of classifying a user to apply for a microloan based on a categorization of user data according to some embodiments herein; and

FIG. 5 is a schematic diagram of a computer architecture in accordance with the embodiments herein.

### DETAILED DESCRIPTION OF THE DRAWINGS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

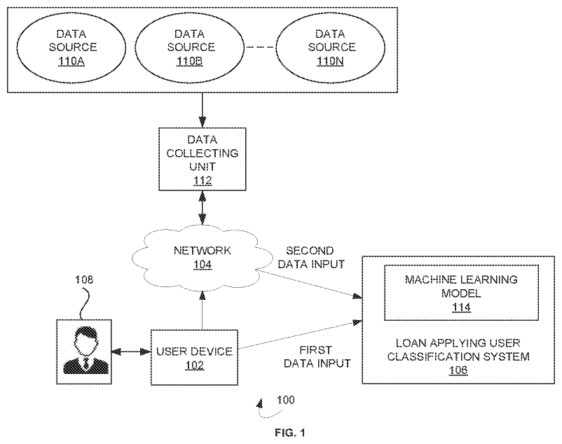

As mentioned, there remains a need for a system for identifying potential users who will accurately apply for a loan with low user acquisition cost, manpower resources, and time. Various embodiments disclosed herein provide a system and method for classifying to apply for a microloan by the user. Referring now to the drawings, and more particularly to FIGS. 1 through 5, where similar reference characters denote corresponding features consistently throughout the figures, preferred embodiments are shown.

FIG. 1 illustrates a block diagram of a system 100 for classifying a user 108 to apply for a microloan according to some embodiments herein. The system 100 includes a user device 102 associated with the user 108, and a loan applying user classification system 106. The loan applying user classification system 106 includes a memory that stores a database and a set of modules, and a processor that executes the set of modules. The loan applying user classification system 106 may be a handheld device, a mobile phone, a kindle, a Personal Digital Assistant (PDA), a tablet, a music player, a computer, an electronic notebook or a smartphone.

The user device 102 is installed with one or more programs by the user 108 and is communicatively connected with the loan applying user classification system 106. The one or more programs may include client-side programs. In some embodiments, the one or more programs is micro-loan application. The loan applying user classification system 106 is configured to receive raw data automatically from the user device 102 that is installed with the one or more programs through a communication network. The user device 102 may be a handheld device, a mobile phone, a kindle, a Personal Digital Assistant (PDA), a tablet, a laptop, a music player, a computer, an electronic notebook, or a smartphone. The communication network may include a wireless network, a wired network, a combination of a wired network, and a wireless network or Internet.

The loan applying user classification system 106 collects data input from at least one of (i) the one or more programs on the user device 102 directly; (ii) the one or more programs indirectly through the network 104 or (iii) both. A program provider of the one or more programs may collect the first data input from the user device 102 directly or send the first data input to a network 104. The network 104 may be a server of the program provider. The loan applying user classification system 106 communicates with the network 104 and indirectly receives second data input collected at the network 104. A data collecting unit 112 receives the second data input from one or more data sources 110A-N and sends the second data input to the loan applying user classification system 106 through the network 104. The loan applying user classification system 106 categorizes the first data input and the second data input to determine a categorized data based on a definition of a first type of data, a second type of data, and a third type of data.

The categorized data may include (i) the first type of data that does not change with respect to time for a particular user 108, (ii) the second type of data that gets changed with respect to a physical location or mobile network of a particular user 108, and (iii) the third type of data that is dependent on user's interaction or behavior inside the one or more programs. The first type of data may include brand, model, screen height, screen width, Operating System version (OsVersion), appInstallSource of the user device 102. The second type of data may include demographic details such as state, city, and country; Mobile Country Code (mcc), Mobile Network Code (mnc), and network. The third type of data may include interaction data such as session timestamp, sessionid, session duration and events performed by the user.

The loan applying user classification system 106 is further configured to (i) pre-process the categorized data to obtain pre-processed data; (ii) identify a representative set of features (i.e. a training dataset) from the pre-processed data; (iii) sample the set of features to obtain balanced dataset; (iv) train a machine learning model 114 by correlating the balanced dataset with a classification of the user to obtain a trained machine learning model and (v) classify, using the trained machine learning model, the user 108 applies for the microloan as positive events, or (b) the user 108 does not apply for the microloan as negative events.

The predicted classification of the user 108 by the trained machine learning model is validated with corresponding real-time data of classification of the user to improve the accuracy of the method. The classified results may be shared with the program provider of the one or more programs from the loan applying user classification system 106 for further action. The program provider of the one or more programs may be a loan lender.

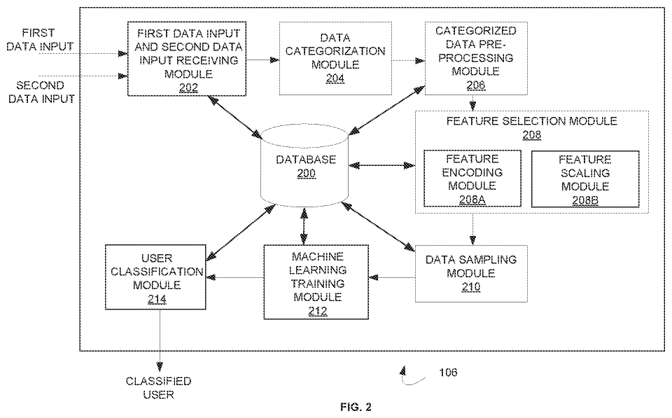

FIG. 2 illustrates a block diagram of a loan applying user classification system 106 of FIG. 1 according to some embodiments herein. The loan applying user classification system 106 includes a database 200, a first data input and second data input receiving module 202, a data categorization module 204, a categorized data pre-processing module 206, a feature selection module 208, a data sampling module 210, a machine learning training module 212, and a user classification module 214.

The first data input and second data input receiving module 202 is communicatively connected with the user device 102 associated with the user 108, and the network 104 associated with the program provider to collect raw data. The first data input and second data input receiving module 202 receive the first data input and second data input from at least one of (i) the user device 102, (ii) the network 104, or (iii) both and stores the first data input and second data input in the database 200. The data categorization module 204 categorizes the first data input and the second data input to determine a categorized data based on the definition of a first type of data, a second type of data and a third type of data. The categorized data may include (i) the first type of data including brand, model, screen height, screen width, OsVersion, appInstallSource of the user device 102; (ii) the second type of data including demographic details such as state, city, and country, Mobile Country Code (mcc), Mobile Network Code (mnc), and network connection; and (iii) the third type of data including interaction data such as session timestamp, sessionid, session duration and events performed by the user associated with the one or more programs installed on the user device 102. The first data input and second data input receiving module 202 may use custom events integrated as a part of software development kit (SDK) to collect the raw data. In some embodiments, the SDK includes fraud detection, retention, session tracking, user flow, etc. The raw data stored in the database 200 may be in a semi-structured format.

The categorized data pre-processing module 206 is configured to pre-process the categorized data that is stored in the database 200 to obtain pre-processed data with insightful (or meaningful) information. The categorized data pre-processing module 206 extracts features from the categorized data. For extracting the features, the categorized data pre-processing module 206 may use a structured query language (SQL) to obtain structured data from the raw data and apply data transformation techniques to extract structured information (i.e. features) from the structured data. The categorized data pre-processing module 206 further standardizes the structured information by standardizing cases, dealing with missing information, null values, and outliers.

The feature selection module 208 identifies a representative set of features that best discriminate the two classes, as a training dataset, from the pre-processed data. The feature selection module 208 eliminates redundancy and selects uncorrelated and salient attributes from the pre-processed data using correlation analysis.

The feature selection module 208 may utilize Cramer's V correlation technique to measure an association between categorical variables that is bounded within the range [0,1], where 0 signifies no association and 1 indicates perfect association. The feature selection module 208 may remove (i) one of the two variables having a degree of correlation greater than a pre-set threshold value of 0.9 and (ii) variables having no association with an outcome variable (or a target variable).

For example, the association between the variables “OsVersion”, “brand” and “model” is high and categorical variables “country”, “state” and “city” also exhibit higher correlation. The feature selection module 208 determines the Cramer's V Correlation between two categorical variables.

The feature selection module 208 may utilize the Pearson Correlation statistics technique to measure an association between numerical attributes. The feature selection module 208 determines Pearson Correlation Coefficient for numerical attributes.

The feature selection module 208 is further configured to perform feature transformation by applying feature transformation techniques on the features to obtain the transformed data. The feature selection module 208 may apply (i) a one-hot encoding mechanism on categorical variables of the features to encode categorical variables to a new set of features indicating the presence or absence of each label values from the features and (ii) a standard scaling method on numerical attributes to scale the values of the numerical attributes in a fixed range.

The feature encoding module 208A and the feature scaling module 208B are configured to perform feature encoding and scaling by applying feature transformation techniques on the features to obtain transformed data. The feature encoding module 208A may apply a one-hot encoding mechanism on categorical variables of the features to encode categorical variables to a new set of features. The one-hot encoding mechanism may convert each label value of a categorical variable to new dichotomous variables indicating the presence of each possible value from the original data or features. The categorical variables may include city, brand, OsVersion, screensize, mccmnc.

The feature scaling module 208B may apply a standard scaling method on numerical variables to scale the values of the numerical attributes in a fixed range such that the mean of the variable is 0 and the corresponding standard deviation is 1. The numerical variables may include active days, total session duration, average session duration, and total sessions.

The identified training dataset after feature selection and transformation may be imbalanced.

The data sampling module 210 is configured to balance an imbalanced training dataset (i.e. representative set of features) identified from the feature selection module 206. The data sampling module 210 adjusts a distribution of both a majority class and a minority class in the training dataset by selecting instances of minority class with a higher frequency. The data sampling module 210 may use a random sampling technique to select the instances of minority class with the higher frequency. The data sampling module 210 may use a random sampling with a replacement approach to duplicate the minority class instances in the training dataset equal to the majority class instances to obtain a balanced dataset. In some embodiments, the balanced dataset has an equal ratio of both the classes of the outcome variable.

The machine learning training module 212 is configured to train the machine learning model 114 on the balanced dataset to obtain a trained machine learning model. The machine learning training module 212 may use a supervised machine learning algorithm for generating the trained machine learning model. The supervised machine learning algorithm may be a logistic regression or Deep Neural Network or Extreme Gradient Boosting algorithm. The user classification module 214 is configured to classify to apply for a microloan by the user 108 by classifying the users into one of the two classes, i.e. borrower and non-borrower.

The machine learning training module 212 is further configured to estimate the results of the classification model 212.

The machine learning training module 212 may validate the resultant classification probabilities of the trained machine learning model with an actual outcome of microloan application status of the user 108 (i.e. validation dataset) to determine if high probabilities are associated with positive events (i.e. user applied for the microloan) and low probabilities determine negative events (i.e. user not applied for the microloan).

Once validated, the trained machine learning model may be used to classify test data associated with the users into classified data (i.e. borrower and non-borrower).

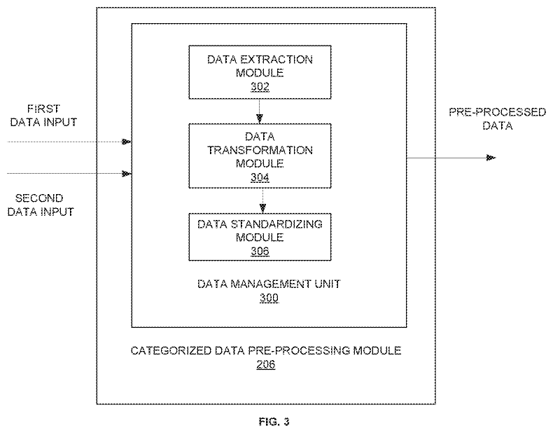

FIG. 3 illustrates a block diagram of a pre-processing module 204 of FIG. 2 according to some embodiments herein. The pre-processing module 204 includes a data extraction module 302, a data transformation module 304, and a data standardizing module 306.

The data extraction module 302 is configured to extract structured data from the raw data that is obtained from the user device 102 and stored in the database 200 in a semi-structured format. The data extraction module 302 may use a structured query language to obtain the structured data. The structured data may include device ID; location data such as country, state, and city; mobile attributes such as brand, model, OsVersion, network, screen height, screen width, appinstallSource, mcc, and mnc; interaction information such as session information including active days, total session duration, average session duration, and total sessions; and label (microloan event). The microloan event may be used as an outcome or target variable.

The data transformation module 304 is configured to extract structured information (i.e. features) from the structured data obtained at the data extraction module 302. The data transformation module 304 may apply data transformation techniques to extract structured information. For example, the data transformation module 304 may transform the structured data such as “screen width” and “screen height” into the structured information, i.e., a new variable named “screensize” (small, medium, large). The data transformation module 304 may combine the structured data “mcc” and “mnc” to form the structured information, i.e., a new variable named “mccmnc”. The variable “mccmnc” may be used to identify a mobile subscriber's network.

The structured information may include device ID; location data such as country, state, and city, mobile attributes such as brand, model, OsVersion, network, screensize, appinstallSource, and mccmnc; interaction information such as active days, total session duration, average session duration, and total sessions; and label (microloan event) that is used as outcome/target variable.

The data standardizing module 306 is configured to standardize the structured information by standardizing cases, dealing with missing information, null values, and outliers. For example, if demographic or mobile attribute information is missing, the data standardizing module 306 may use default as “unknown” to fill the missing information. If the session of the user 108 information is not available, the data standardizing module 306 may use “0” as default.

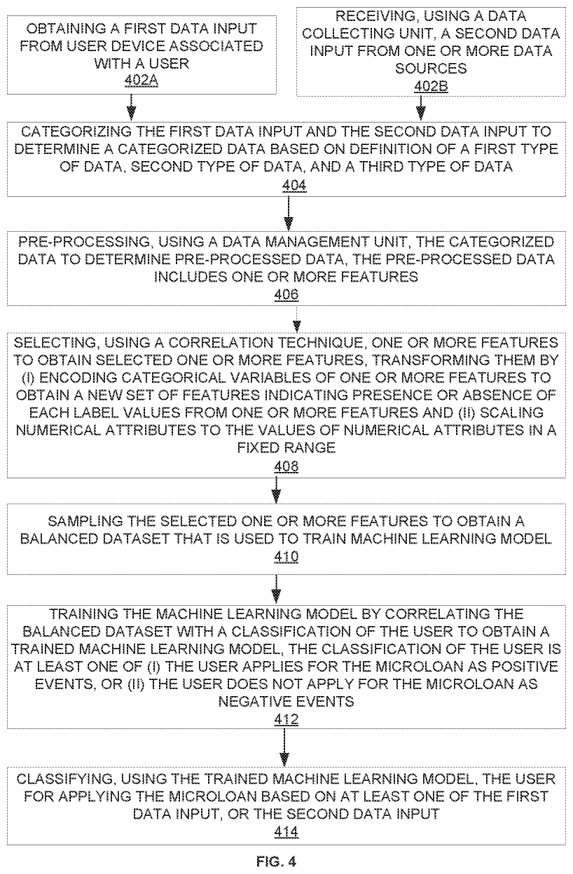

FIG. 4 is a flow diagram that illustrates a method of classifying a user 108 to apply for a microloan based on a categorization of user data according to some embodiments herein. At step 402A, the method includes, obtaining a first data input from the user device 102 associated with the user 108. At step 402B, the method includes, receiving, using a data collecting unit, a second data input from a plurality of data sources through the network 104. At step 404, the method includes, categorizing the first data input and the second data input to determine a categorized data based on the definition of a first type of data, a second type of data, and a third type of data. The categorized data may include (i) the first type of data including brand, model, screen height, screen width, OsVersion, appInstallSource of the user device 102; (ii) the second type of data including demographic details such as state, city, and country, Mobile Country Code (mcc), Mobile Network Code (mnc), and network; and (iii) the third type of data including interaction data such as session timestamp, sessionid, session duration and events performed by the user associated with the one or more programs installed on the user device 102.

At step 406, the method includes, pre-processing, using a data management unit 112, the categorized data to determine pre-processed data. In some embodiments, the pre-processed data includes one or more features. At step 408, the method includes, selecting one or more features to obtain selected one or more features. In some embodiments, the method includes transforming the selected one or more features by (i) encoding categorical variables of one or more features to obtain a new set of features indicating the presence or absence of each label values from one or more features and (ii) scaling numerical attributes to the values of numerical attributes in a fixed range.

At step 410, the method includes, sampling, using a correlation technique, the selected one or more features to obtain a balanced dataset that is used to train the machine learning model. At step 412, the method includes, training the machine learning model by correlating the balanced dataset with a classification of the user to obtain a trained machine learning model. In some embodiments, the classification of the user is at least one of (a) the user applies for the microloan as positive events, or (b) the user does not apply for the microloan as negative events. At step 414, the method includes, classifying, using the trained machine learning model, the user for applying the microloan based on at least one of the first data input, or the second data input.

In some exemplary embodiments, the loan applying user classification system 106 collects raw data automatically from the user device 102 that is installed with a microloan application. The collected raw data may be provided in Table 1.

TABLE 1

| | event | event | session | session | | | | |
|---|---|---|---|---|---|---|---|---|
| gaid | name | timestamp | time stamp | duration | sessionid | OsVersion | model | city |
| ffaec1eb- | null | null | null | null | null | 10 | Redmi | Bhubaneswar |
| c1ba-4934- | | | | | | | Note | |
| b850- | | | | | | | 9 Pro | |
| 7a5f461d1021 | | | | | | | Max | |
| ffaec1eb- | registration | 2021-04-14 | null | null | null | 10 | Redmi | Bhubaneswar |
| c1ba-4934- | | 18:38:59 | | | | | Note | |
| b850- | | UTC | | | | | 9 Pro | |
| 7a5f461d1021 | | | | | | | Max | |
| ffaec1eb- | null | null | 2021-04-14 | 20 | 16184255087740uflX | 10 | Redmi | Bhubaneswar |
| c1ba-4934- | | | 18:38:28 | | | | Note | |
| b850- | | | UTC | | | | 9 Pro | |
| 7a5f461d1021 | | | | | | | Max | |
| dd782ea3- | null | null | null | null | null | 11 | SM- | Mumbai |
| 4ac1-431c- | | | | | | | M307F | |
| 83aa- | | | | | | | | |
| e6c367b91s28 | | | | | | | | |
| dd782ea3- | registration | 2021-04-14 | 2021-04-14 | 20 | 1618430633520D8e7s | 11 | SM- | Mumbai |
| 4ac1-431c- | | 20:04:10 | 20:03:53 | | | | M307F | |
| 83aa- | | UTC | UTC | | | | | |
| e6c367b91s28 | | | | | | | | |
| df3c8256- | null | null | null | null | null | 10 | Redmi | Jaipur |
| 5afd-4ae2- | | | | | | | K20 | |
| 86bd- | | | | | | | | |
| 12ad8662c154 | | | | | | | | |
| df3c8256- | registration | 2021-04-14 | 2021-04-14 | 20 | 1618430869684B1Bej | 10 | Redmi | Jaipur |
| 5afd-4ae2- | | 20:08:00 | 20:07:49 | | | | K20 | |
| 86bd- | | UTC | UTC | | | | | |
| 12ad8662c154 | | | | | | | | |
| df3c8256- | null | null | 2021-04-14 | 13 | 16184309159958wL3g | 10 | Redmi | Jaipur |
| 5afd-4ae2- | | | 20:08:35 | | | | K20 | |
| 86bd- | | | UTC | | | | | |
| 12ad8662c154 | | | | | | | | |
| fe21b9ff- | null | null | null | null | null | 11 | V2025 | Barnagar |
| 3ad8-4941- | | | | | | | | |
| 9b7c- | | | | | | | | |
| 4c2e1a7f6152 | | | | | | | | |
| fe21b9ff- | registration | 2021-04-15 | 2021-04-15 | 20 | 1618488054739E1dZi | 11 | V2025 | Barnagar |
| 3ad8-4941- | | 12:01:08 | 12:00:54 | | | | | |
| 9b7c- | | UTC | UTC | | | | | |
| 4c2e1a7f6152 | | | | | | | | |
| de6df0a4- | registration | 2021-04-15 | 2021-04-15 | 20 | 16184842976532BgVl | 11 | SM- | Chennai |
| d22b-49ee- | | 10:58:37 | 10:58:17 | | | | A505F | |
| be66- | | UTC | UTC | | | | | |
| b80d0b5c55a1 | | | | | | | | |
| de6df0a4- | loan_apply | 2021-04-15 | 2021-04-15 | 160 | 16184892976532BgVl | 11 | SM- | Chennai |
| d22b-49ee- | | 16:58:37 | 16:58:17 | | | | A505F | |
| be66- | | UTC | UTC | | | | | |
| b80d0b5c55a1 | | | | | | | | |

| | | | | | screen | | | screen | |
|---|---|---|---|---|---|---|---|---|---|
| gaid | country | mcc | network | brand | width | mnc | state | height | appInstallSource |
| ffaec1eb- | India | 405 | 4G | Xiaomi | 1080 | 866 | Odisha | 2168 | com.android.vending |
| c1ba-4934- | | | | | | | | | |
| b850- | | | | | | | | | |
| 7a5f461d1021 | | | | | | | | | |
| ffaec1eb- | India | 405 | 4G | Xiaomi | 1080 | 866 | Odisha | 2168 | com.android.vending |
| c1ba-4934- | | | | | | | | | |
| b850- | | | | | | | | | |
| 7a5f461d1021 | | | | | | | | | |
| ffaec1eb- | India | 405 | 4G | Xiaomi | 1080 | 866 | Odisha | 2168 | com.android.vending |
| c1ba-4934- | | | | | | | | | |
| b850- | | | | | | | | | |
| 7a5f461d1021 | | | | | | | | | |
| dd782ea3- | India | 405 | 4G | samsung | 1080 | 874 | Maharashtra | 2131 | com.android.vending |
| 4ac1-431c- | | | | | | | | | |
| 83aa- | | | | | | | | | |
| e6c367b91s28 | | | | | | | | | |
| dd782ea3- | India | 405 | 4G | samsung | 1080 | 874 | Maharashtra | 2131 | com.android.vending |
| 4ac1-431c- | | | | | | | | | |
| 83aa- | | | | | | | | | |
| e6c367b91s28 | | | | | | | | | |
| df3c8256- | India | 405 | 4G | Xiaomi | 1080 | 868 | Rajasthan | 2210 | com.android.vending |
| 5afd-4ae2- | | | | | | | | | |
| 86bd- | | | | | | | | | |
| 12ad8662c154 | | | | | | | | | |
| df3c8256- | India | 405 | 4G | Xiaomi | 1080 | 868 | Rajasthan | 2210 | com.android.vending |
| 5afd-4ae2- | | | | | | | | | |
| 86bd- | | | | | | | | | |
| 12ad8662c154 | | | | | | | | | |
| df3c8256- | India | 405 | 4G | Xiaomi | 1080 | 868 | Rajasthan | 2210 | com.android.vending |
| 5afd-4ae2- | | | | | | | | | |
| 86bd- | | | | | | | | | |
| 12ad8662c154 | | | | | | | | | |
| fe21b9ff- | India | 404 | wifi | vivo | 1080 | 93 | Madhya | 2208 | com.android.vending |
| 3ad8-4941- | | | | | | | Pradesh | | |
| 9b7c- | | | | | | | | | |
| 4c2e1a7f6152 | | | | | | | | | |
| fe21b9ff- | India | 404 | wifi | vivo | 1080 | 93 | Madhya | 2208 | com.android.vending |
| 3ad8-4941- | | | | | | | Pradesh | | |
| 9b7c- | | | | | | | | | |
| 4c2e1a7f6152 | | | | | | | | | |
| de6df0a4- | India | 404 | 4G | samsung | 1080 | 49 | Tamil | 2131 | com.android.vending |
| d22b-49ee- | | | | | | | Nadu | | |
| be66- | | | | | | | | | |
| b80d0b5c55a1 | | | | | | | | | |
| de6df0a4- | India | 404 | 4G | samsung | 1080 | 49 | Tamil | 2131 | com.android.vending |
| d22b-49ee- | | | | | | | Nadu | | |
| be66- | | | | | | | | | |
| b80d0b5c55a1 | | | | | | | | | |

The loan applying user classification system 106 obtains pre-processed data from the raw data using pre-processing techniques provided in Table 2

TABLE 2

| gaid | OsVersion | state | city | mccmnc | brand | model | network |
|---|---|---|---|---|---|---|---|
| ffaec1eb- | 10 | odisha | bhubaneswar | 405866 | xiaomi | redmi | 4G |
| c1ba-4934- | | | | | | note | |
| b850- | | | | | | 9 pro | |
| 7a5f461d1021 | | | | | | max | |
| dd782ea3- | 11 | maharashtra | mumbai | 405874 | samsung | sm- | 4G |
| 4ac1-431c- | | | | | | m307f | |
| 83aa- | | | | | | | |
| e6c367b91s28 | | | | | | | |
| df3c8256- | 10 | rajasthan | jaipur | 405868 | xiaomi | redmi | 4G |
| 5afd-4ae2- | | | | | | k20 | |
| 86bd- | | | | | | | |
| 12ad8662c154 | | | | | | | |
| fe21b9ff- | 11 | madhya | barnagar | 40493 | vivo | v2025 | wifi |
| 3ad8-4941- | | pradesh | | | | | |
| 9b7c- | | | | | | | |
| 4c2e1a7f6152 | | | | | | | |
| de6df0a4- | 11 | tamil | chennai | 40449 | samsung | sm- | 4G |
| d22b-49ee- | | nadu | | | | a505f | |
| be66- | | | | | | | |
| b80d0b5c55a1 | | | | | | | |

| | | | | total | average | | |
|---|---|---|---|---|---|---|---|
| | | | total | session | session | active | |
| gaid | screensize | appInstallSource | sessions | duration | duration | days | label |
| ffaec1eb- | large | com.android.vending | 1 | 20 | 20 | 1 | 0 |
| c1ba-4934- | | | | | | | |
| b850- | | | | | | | |
| 7a5f461d1021 | | | | | | | |
| dd782ea3- | large | com.android.vending | 1 | 20 | 20 | 1 | 0 |
| 4ac1-431c- | | | | | | | |
| 83aa- | | | | | | | |
| e6c367b91s28 | | | | | | | |
| df3c8256- | large | com.android.vending | 2 | 33 | 16.5 | 2 | 0 |
| 5afd-4ae2- | | | | | | | |
| 86bd- | | | | | | | |
| 12ad8662c154 | | | | | | | |
| fe21b9ff- | large | com.android.vending | 1 | 20 | 20 | 1 | 0 |
| 3ad8-4941- | | | | | | | |
| 9b7c- | | | | | | | |
| 4c2e1a7f6152 | | | | | | | |
| de6df0a4- | large | com.android.vending | 2 | 180 | 90 | 1 | 1 |
| d22b-49ee- | | | | | | | |
| be66- | | | | | | | |
| b80d0b5c55a1 | | | | | | | |

The loan applying user classification system 106 applies Cramer's V correlation technique on categorical features after obtaining features from the raw data using pre-processing techniques to select uncorrelated and salient attributes. The results of the correlation analysis on categorical features are tabulated in Table 3.

TABLE 3

| | label | OsVersion | model | city | mccmnc | network | brand | state | appInstallSource | screensize |
|---|---|---|---|---|---|---|---|---|---|---|
| label | 1.00 | 0.09 | 0.10 | 0.02 | 0.04 | 0.01 | 0.08 | 0.01 | 0.00 | 0.08 |
| OsVersion | 0.09 | 1.00 | 0.88 | 0.12 | 0.08 | 0.07 | 0.42 | 0.02 | 0.06 | 0.44 |
| model | 0.10 | 0.88 | 1.00 | 0.25 | 0.40 | 0.22 | 0.97 | 0.50 | 0.35 | 0.93 |
| city | 0.02 | 0.12 | 0.25 | 1.00 | 0.50 | 0.26 | 0.16 | 0.98 | 0.28 | 0.06 |
| mccmnc | 0.04 | 0.08 | 0.40 | 0.50 | 1.00 | 0.21 | 0.15 | 0.58 | 0.10 | 0.09 |
| network | 0.01 | 0.07 | 0.22 | 0.26 | 0.21 | 1.00 | 0.09 | 0.17 | 0.06 | 0.04 |
| brand | 0.08 | 0.42 | 0.97 | 0.16 | 0.15 | 0.09 | 1.00 | 0.13 | 0.15 | 0.32 |
| state | 0.01 | 0.02 | 0.50 | 0.98 | 0.58 | 0.17 | 0.13 | 1.00 | 0.27 | 0.06 |
| appInstallSource | 0.00 | 0.06 | 0.35 | 0.28 | 0.10 | 0.06 | 0.15 | 0.27 | 1.00 | 0.06 |
| screensize | 0.08 | 0.44 | 0.93 | 0.06 | 0.09 | 0.04 | 0.32 | 0.06 | 0.06 | 1.00 |

The loan applying user classification system 106 applies Pearson Correlation statistics technique on numerical features after obtaining features from the raw data using pre-processing techniques to select uncorrelated and salient attributes. The results of the correlation analysis on numerical features are tabulated in Table 4.

TABLE 4

| | | | average | | |
|---|---|---|---|---|---|
| | | total session | session | total | |
| | label | duration | duration | sessions | active days |
| label | 1.00 | 0.25 | 0.12 | 0.35 | 0.17 |
| total session | 0.25 | 1.00 | 0.54 | 0.54 | 0.09 |
| duration | | | | | |
| average | 0.12 | 0.54 | 1.00 | 0.08 | 0.05 |
| session | | | | | |
| duration | | | | | |
| total sessions | 0.35 | 0.54 | 0.08 | 1.00 | 0.17 |
| active days | 0.17 | 0.09 | 0.05 | 0.17 | 1.00 |

TABLE 5

| | | | | | | | total | average | | |
|---|---|---|---|---|---|---|---|---|---|---|
| | | | | | | total | session | session | active | |
| gaid | OsVersion | city | mccmnc | brand | screensize | sessions | duration | duration | days | label |
| ffaec1eb- | 10 | bhubaneswar | 405866 | xiaomi | large | 1 | 20 | 20 | 1 | 0 |
| c1ba-4934- | | | | | | | | | | |
| b850- | | | | | | | | | | |
| 7a5f461d1021 | | | | | | | | | | |
| dd782ea3- | 11 | mumbai | 405874 | samsung | large | 1 | 20 | 20 | 1 | 0 |
| 4ac1-431c- | | | | | | | | | | |
| 83aa- | | | | | | | | | | |
| e6c367b91s28 | | | | | | | | | | |
| df3c8256- | 10 | Jaipur | 405868 | xiaomi | large | 2 | 33 | 16.5 | 2 | 0 |
| 5afd-4ae2- | | | | | | | | | | |
| 86bd- | | | | | | | | | | |
| 12ad8662c154 | | | | | | | | | | |
| fe21b9ff- | 11 | barnagar | 40493 | vivo | large | 1 | 20 | 20 | 1 | 0 |
| 3ad8-4941- | | | | | | | | | | |
| 9b7c- | | | | | | | | | | |
| 4c2e1a7f6152 | | | | | | | | | | |
| de6df0a4- | 11 | chennai | 40449 | samsung | large | 2 | 180 | 90 | 1 | 1 |
| d22b-49ee- | | | | | | | | | | |
| be66- | | | | | | | | | | |
| b80d0b5c55a1 | | | | | | | | | | |

TABLE 6

| OsVersion_{—} | OsVersion_{—} | city_{—} | city_{—} | city_{—} | city_{—} | city_{—} | brand_{—} | brand_{—} | brand_{—} | screensize_{—} | screensize_{—} |
|---|---|---|---|---|---|---|---|---|---|---|---|
| 10 | 11 | bhubaneswar | barnagar | chennai | jaipur | mumbai | samsung | xiaomi | vivo | small | medium |
| 1 | 0 | 1 | 0 | 0 | 0 | 0 | 0 | 1 | 0 | 0 | 0 |
| 0 | 1 | 0 | 0 | 0 | 0 | 1 | 1 | 0 | 0 | 0 | 0 |
| 1 | 0 | 0 | 0 | 0 | 1 | 0 | 0 | 1 | 0 | 0 | 0 |
| 0 | 1 | 0 | 1 | 0 | 0 | 0 | 0 | 0 | 1 | 0 | 0 |
| 0 | 1 | 0 | 0 | 1 | 0 | 0 | 1 | 0 | 0 | 0 | 0 |
| 0 | 1 | 0 | 0 | 1 | 0 | 0 | 1 | 0 | 0 | 0 | 0 |
| 0 | 1 | 0 | 0 | 1 | 0 | 0 | 1 | 0 | 0 | 0 | 0 |
| 0 | 1 | 0 | 0 | 1 | 0 | 0 | 1 | 0 | 0 | 0 | 0 |

| | | | | | | | total | average | | |
|---|---|---|---|---|---|---|---|---|---|---|
| screensize_{—} | mccmnc_{—} | mccmnc_{—} | mccmnc_{—} | mccmnc_{—} | mccmnc_{—} | total | session | session | active | |
| large | 405866 | 405874 | 405868 | 40493 | 40449 | sessions | duration | duration | days | label |
| 1 | 1 | 0 | 0 | 0 | 0 | −0.73 | −0.49 | −0.42 | −0.45 | 0 |
| 1 | 0 | 1 | 0 | 0 | 0 | −0.73 | −0.49 | −0.42 | −0.45 | 0 |
| 1 | 0 | 0 | 1 | 0 | 0 | 1.1 | −0.31 | −0.53 | 1.79 | 0 |
| 1 | 0 | 0 | 0 | 1 | 0 | −0.73 | −0.49 | −0.42 | −0.45 | 0 |
| 1 | 0 | 0 | 0 | 0 | 1 | 1.1 | 1.78 | 1.79 | −0.45 | 1 |
| 1 | 0 | 0 | 0 | 0 | 1 | 1.1 | 1.78 | 1.79 | −0.45 | 1 |
| 1 | 0 | 0 | 0 | 0 | 1 | 1.1 | 1.78 | 1.79 | −0.45 | 1 |
| 1 | 0 | 0 | 0 | 0 | 1 | 1.1 | 1.78 | 1.79 | −0.45 | 1 |

The loan applying user classification system 106 obtains a selected dataset as shown in Table 5 after data pre-processing and feature selection and a training dataset as shown in Table 6 after feature transformation and data sampling.

TABLE 7

| | | | | | | | total | average | | |
|---|---|---|---|---|---|---|---|---|---|---|
| | | | | | | total | session | session | active | Predicted |
| gaid | OsVersion | city | mccmnc | brand | Screensize | sessions | duration | duration | days | Probabilities |
| fe64c0a5- | 11 | dhanbad | 40449 | samsung | large | 2 | 180 | 90 | 1 | 0.71 |
| d11b-49ee- | | | | | | | | | | |
| bd44- | | | | | | | | | | |
| b80d0b4c75a0 | | | | | | | | | | |

The loan applying user classification system 106 trains the machine learning model using the training dataset shown in Table 6 to obtain the classification model. In some exemplary embodiments, the following is a sample data set (or test data).

For the sample dataset in Table 7, the loan applying user classification system 106 calculates the likelihood that the user will apply for a loan with the classification model using the equation (For Logistic regression) as follows.

p(y)=1/(1+e\hat{ }−(1.13−4.43+3.36+0.83+ . . . ))=0.71 i.e. 71%, where x is the predicted log it of outcome variable y which is determined as follows:

x=log it(y)=1.13+(−4.43)*city(dhanbad)+3.36*brand(samsung)+0.83*screensize(large)+ . . . , where the values are weights associated with individual features. For example, City Dhanbad has a weight of −4.43 and Brand Samsung has a weight of 3.36.

The system 100 classifies the user's likelihood to apply for the microloan by utilizing non-traditional data such as mobile footprints and behavioral data of the smartphone users rather than utilizing historical financial attributes. Hence, the system 100 facilitates low-cost automated assessment (likelihood to apply for the microloan) of small borrowers that would otherwise very difficult to assess using traditional methods in the absence of their financial data. The system 100 further facilitates the loan lenders to get early feedback about the quality of user acquisition channels, lower their user acquisition costs, save their corporate/manpower resources and efforts by focusing on a narrower relevant user segment. In addition, the system 100 enables loan lenders to make quick business decisions. Further, with the system 100, the loan lenders can devise new strategies to attract the opposite group (whose likelihood to apply for the microloan is on the lower side). The system 100 collects the raw data from the one or more programs running on the user device 102 without any manual intervention either directly or indirectly using a server to server communication. The system 100 utilizes a correlation-based approach to avoid multicollinearity in data and reduce dimensionality as logistic regression/Deep Neural Network/Extreme Gradient Boosting (XGBoost) may be sensitive to multicollinearity. The system 100 evens out the distribution of both majority and minority classes using random sampling with replacement approach. Hence, a bias of the classification model towards the majority class is avoided. Thus, the system 100 helps the loan lenders to identify potential users/borrowers (who will apply for a loan) accurately with low user acquisition cost, manpower resources, and time.

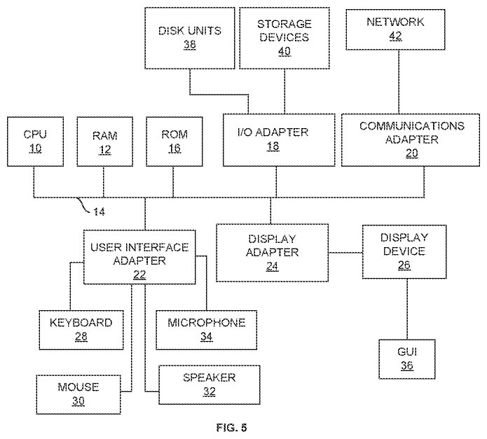

A representative hardware environment for practicing the embodiments herein is depicted in FIG. 5, with reference to FIGS. 1 through 4. This schematic drawing illustrates a hardware configuration of a server/computer system/computing device in accordance with the embodiments herein. The system includes at least one processing device CPU 10 that may be interconnected via system bus 14 to various devices such as a random access memory (RAM) 12, read-only memory (ROM) 16, and an input/output (I/O) adapter 18. The I/O adapter 18 can connect to peripheral devices, such as disk units 38 and program storage devices 40 that are readable by the system. The system can read the inventive instructions on the program storage devices 40 and follow these instructions to execute the methodology of the embodiments herein. The system further includes a user interface adapter 22 that connects a keyboard 28, mouse 30, speaker 32, microphone 34, and/or other user interface devices such as a touch screen device (not shown) to the bus 14 to gather user input. Additionally, a communication adapter 20 connects the bus 14 to a data processing network 42, and a display adapter 24 connects the bus 14 to a display device 26, which provides a graphical user interface (GUI) 36 of the output data in accordance with the embodiments herein, or which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications without departing from the generic concept, and, therefore, such adaptations and modifications should be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of appended claims.

What is claimed is:

1. A processor-implemented method for classifying a user into at least one of a borrower or a non-borrower for a microloan, based on categorization of user data acquired from a user device or a plurality of data sources using a machine learning model, thereby assessing user's likelihood to apply for the microloan, the method comprising using a loan applying user classification system:
obtaining a first data associated with the user from the user device that is installed with a micro-loan application;
receiving, using a data collecting unit, a second data associated with the user from the plurality of data sources;
characterized in that, the method comprises,
generating a categorized user data by categorizing the first data and the second data based on a definition of a first type of user data, a second type of user data and a third type of user data, wherein the categorized user data comprises (i) the first type of user data that comprises a plurality of details of the user device comprising at least one of a brand, a model, a screen height, a screen width, an operating system (OS) Version, or an application installation source of the user device, (ii) the second type of user data that comprises demographic data of the user, and (iii) the third type of user data that comprises user's online interaction with the micro-loan application;
generating a pre-processed user data that comprises a plurality of features extracted from the categorized user data by pre-processing, using a data management unit (300), the categorized user data;
selecting, using a correlation technique, a set of features that has association with an outcome variable, from the plurality of features, wherein the outcome variable is a microloan event;
transforming the selected set of features by, (i) encoding categorical variables of the selected set of features to obtain a new set of features indicating the presence or absence of each label value from the selected plurality of features, and (ii) scaling numerical attributes to the values of numerical attributes in a fixed range;
sampling, using a random sampling technique, to obtain a balanced dataset from a transformed set of features, that is used to train the machine learning model;
training the machine learning model by correlating the balanced dataset with a classification of the user to obtain a trained machine learning model, wherein the classification of the user comprises at least one of (a) the user applies for the microloan as positive events, or (b) the user does not apply for the microloan as negative events; and
classifying, using the trained machine learning model, the user into at least one of the borrower or the non-borrower for applying the microloan based on at least one of the first data acquired from the user device or the second data acquired from the plurality of data sources, thereby assessing user's likelihood to apply for the microloan.

2. The processor-implemented method of claim 1, wherein the method comprises selecting, using the correlation technique, the plurality of features by at least one of, (i) measuring an association between the categorical variables of the plurality of features that is bounded within the range [0,1], where 0 signifies no association and 1 signifies perfect association, or (ii) measuring an association between the numerical attributes.

3. The processor-implemented method of claim 2, wherein the method comprises removing one of two categorical variables of the set of features whose degree of correlation is greater than a pre-set threshold value and removing categorical variables of the set of features having no association with the outcome variable.

4. The processor-implemented method of claim 1, wherein the method comprises encoding the categorical variables of the plurality of features by converting each label values to new dichotomous variables to indicate the presence of each possible value from the plurality of features and scaling numerical attributes to the values of numerical attributes in the fixed range such that the mean of the numerical attributes is zero, and corresponding standard deviation is one.

5. The processor-implemented method of claim 1, wherein the method comprises validating a predicted classification of the user by the trained machine learning model with corresponding real-time data of classification of the user to improve accuracy of the method.

6. The processor-implemented method of claim 1, wherein the method comprises retraining the machine learning model if there is a misalignment between the classification of the user with real-time data by determining the positive events and the negative events, wherein the positive events and negative events samples are used in retraining the machine learning model.

7. The processor-implemented method of claim 1, wherein the categorized user data is pre-processed by,
extracting, using the data management unit, structured data from the categorized user data;
transforming, using a data transformation technique, the structured data into a transformed data by combining at least two variables into a new variable; and
standardizing the transformed data by standardizing cases, dealing with missing information, null values, or outliers to obtain the pre-processed user data.

8. A system for classifying a user into at least one of a borrower or a non-borrower for a microloan, based on categorization of user data acquired from a user device or a plurality of data sources using a machine learning model, thereby assessing user's likelihood to apply for the microloan, wherein the system comprises:
a memory that stores a database and a set of instructions;
a processor that is configured to execute the set of instructions and is configured to
a first data associated with the user from the user device associated with the user;
receive, using a data collecting unit, a second data associated with the user from the plurality of data sources;
characterized in that,
generate a categorized user data by categorizing the first data and the second data based on a definition of a first type of user data, a second type of user data and a third type of user data, wherein the categorized user data comprises (i) the first type of user data that comprises a plurality of details of the user device comprising at least one of a brand, a model, a screen height, a screen width, an operating system (OS) Version, or an application installation source of the user device, (ii) the second type of user data that comprises demographic data of the user, and (iii) the third type of user data that comprises user's online interaction with the micro-loan application;
generate a pre-processed user data that comprises a plurality of features extracted from the categorized user data by pre-processing, using a data management unit (300), the categorized user data;
select, using a correlation technique, a set of features that has association with an outcome variable, from the plurality of features, wherein the outcome variable is a microloan event;
transform the selected set of features by, (i) encoding categorical variables of the selected set of features to obtain a new set of features indicating the presence or absence of each label value from the selected plurality of features, and (ii) scaling numerical attributes to the values of numerical attributes in a fixed range;
sample, using a random sampling technique, to obtain a balanced dataset from a transformed set of features, that is used to train the machine learning model,
train the machine learning model by correlating the balanced dataset with a classification of the user to obtain a trained machine learning model, wherein the classification of the user comprises at least one of (a) the user applies for the microloan as positive events, or (b) the user does not apply for the microloan as negative events; and
classify, using the trained machine learning model, the user into at least one of the borrower or the non-borrower for applying the microloan based on at least one of the first data acquired from the user device or the second data acquired from the plurality of data sources, thereby assessing user's likelihood to apply for the microloan.

9. The system of claim 8, wherein the processor is configured to select, using the correlation technique, the plurality of features by at least one of, (i) measuring an association between the categorical variables of the plurality of features that is bounded within the range [0,1], where 0 signifies no association and 1 signifies perfect association, or (ii) measuring an association between the numerical attributes.

10. The system of claim 9, wherein the processor is configured to remove one of two categorical variables of the set of features whose degree of correlation is greater than a pre-set threshold value and removing categorical variables of the set of features having no association with the outcome variable.

11. The system of claim 8, wherein the processor is configured to encode the categorical variables of the plurality of features by converting each label values to new dichotomous variables to indicate the presence of each possible value from the plurality of features and scaling numerical attributes to the values of numerical attributes in the fixed range such that the mean of the numerical attributes is zero, and corresponding standard deviation is one.

12. The system of claim 8, wherein the processor is configured to validate a predicted classification of the user by the trained machine learning model with corresponding real-time data of classification of the user to improve accuracy of the method.

13. The system of claim 8, wherein the processor is configured to retrain the machine learning model if there is a misalignment between the classification of the user with real-time data by determining the positive events and the negative events, wherein the positive events and negative events samples are used in retraining the machine learning model.

14. The system of claim 8, wherein the categorized user data is pre-processed by,
extracting, using the data management unit, structured data from the categorized user data;
transforming, using a data transformation technique, the structured data into a transformed data by combining at least two variables into a new variable; and
standardizing the transformed data by standardizing cases, dealing with missing information, null values, or outliers to obtain the pre-processed user data.

15. One or more non-transitory computer-readable storage mediums storing one or more sequences of instructions, which when executed by one or more processors, causes a method for dynamically updating a project plan using natural language processing and an artificial intelligence (AI) model performing steps of:
obtaining a first data associated with the user from the user device that is installed with a micro-loan application;
receiving, using a data collecting unit, a second data associated with the user from the plurality of data sources;
characterized in that, the method comprises,
generating a categorized user data by categorizing the first data and the second data based on a definition of a first type of user data, a second type of user data and a third type of user data, wherein the categorized user data comprises (i) the first type of user data that comprises a plurality of details of the user device comprising at least one of a brand, a model, a screen height, a screen width, an operating system (OS) Version, or an application installation source of the user device, (ii) the second type of user data that comprises demographic data of the user, and (iii) the third type of user data that comprises user's online interaction with the micro-loan application;
generating a pre-processed user data that comprises a plurality of features extracted from the categorized user data by pre-processing, using a data management unit (300), the categorized user data;
selecting, using a correlation technique, a set of features that has association with an outcome variable, from the plurality of features, wherein the outcome variable is a microloan event;
transforming the selected set of features by, (i) encoding categorical variables of the selected set of features to obtain a new set of features indicating the presence or absence of each label value from the selected plurality of features, and (ii) scaling numerical attributes to the values of numerical attributes in a fixed range;
sampling, using a random sampling technique, to obtain a balanced dataset from a transformed set of features, that is used to train the machine learning model;
training the machine learning model by correlating the balanced dataset with a classification of the user to obtain a trained machine learning model, wherein the classification of the user comprises at least one of (a) the user applies for the microloan as positive events, or (b) the user does not apply for the microloan as negative events; and classifying, using the trained machine learning model, the user into at least one of the borrower or the non-borrower for applying the microloan based on at least one of the first data acquired from the user device or the second data acquired from the plurality of data sources, thereby assessing user's likelihood to apply for the microloan.
